(19) United States
(12) Patent Application Publication
(10) Pub. No.: US 2007/0214364 A1
(43) Pub. Date: Sep. 13, 2007

(54) Dual layer authentication system for securing user access to remote systems and associated methods

(76) Inventor: Nicole A. Roberts, Rockwall, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/369,568

(22) Filed: Mar. 7, 2006

(51) Int. Cl. H04L 9/00

(52) U.S. Cl. 713/179

(57) ABSTRACT

A dual layer authentication system is disclosed for securing user access to remote systems having verification units coupled to a user authentication system that generates authentication-PINs for subsequent use in logging on to remote systems. An access control system is coupled to the user authentication system and receives login requests from remote systems including the authentication-PINs issued by the user authentication system. The access control system approves access to remote systems if the authentication-PIN is verified. Preferably, the authentication-PINs are configured to be temporary. In addition, verification data can be stored on a smart card, and this verification data is verified by the verification unit with the minimal information having to be transmitted through the communications network between the verification unit and the user authentication system.

### TECHNICAL FIELD OF THE INVENTION

This invention relates to user authentication systems for securing user access to remote systems. More particularly, the invention relates to secured communication systems requiring user verification for access to communication system channels.

### BACKGROUND

Prior verification systems exist to verify users for access to secured systems. When using secured systems, several forms of identification have been required to help prevent security breaches. With remote systems, users may not feel safe inputting several personal forms of identification for fear that their identity could be stolen. Verification units are currently used to verify a user's identity for authentication at a higher level. The verification units have been implemented to require several forms of identification, such as a biometric identification and a password. However, current verification systems that accept multiple forms of authentication for user verification are stand alone units that record very little information except a user access log. Use of a separate user verification system for each remote system can be cumbersome, take up space, and with regard to aircraft systems, can be a burden with regard to weight. Prior verification systems also do not handle different security levels such that the verification system is unable to cooperate with a multi-level security (MLS) system. Further, current verification systems do not fully take advantage of the Department of Defense (DOD) Common Access Card (CAC).

### SUMMARY OF THE INVENTION

The present invention provides a dual layer authentication system for securing user access to remote systems. In one implementation, the system has a verification unit configured to receive multiple types of user verification information as inputs (e.g., information stored on a smart card, biometric data, user personal identification number (user-PIN)), and the system is further configured to verify a user of the smart card based upon the verification information. In addition to one or more verification units, the system includes a user authentication system coupled to the verification units to receive a verification indication concerning the user of the smart card in addition to other user related information. The user authentication system is configured to generate an authentication personal identification number (authentication-PIN) associated with a positive verification of the user and to provide the authentication-PIN to the verification unit for receipt by the user of the smart card. Also included in the system is an access control system coupled to the user authentication system. The access control system is configured to receive user login requests from remote systems, including user identification and authentication-PIN information. The access control system is further configured to communicate with the user authentication system to verify the authentication-PIN and to approve access to the remote system or other system resources if the authentication-PIN is verified. As described below, other features and variations can be implemented, if desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of a user authentication system having verification units.

FIG. 2 is a block diagram of a remote system authentication with an access control system.

FIG. 3 is a block diagram of a user authentication system having verification units and an access control system for user login to remote systems.

FIG. 4 is a flowchart of the steps of an embodiment of user login to remote systems via a user authentication system having verification units and an access control system.

### DETAILED DESCRIPTION OF THE INVENTION

The present invention provides a user authentication system with dual layer authentication for securing access to remote systems. One embodiment of the present invention includes a user authentication system communicating with a verification unit that utilizes three forms of identification from a user. Once user information is verified, an authentication personal identification number (authentication-PIN) is issued to the user by user authentication system for user permission/login to remote systems. The user then uses this authentication-PIN to log into remote systems, and a separate access control system communicates with the user authentication system to confirm the validity of the authentication-PIN. The forms of user identification can include a biometric identification (e.g., thumbprint, eye scan), a password, and a physical item, such as a smart card. These example forms of user identification provide information known by the user (user-PIN), information possessed by the user (smart card), and information that is the user (biometric). User permissions can include clearance levels, special access levels, and special project lists. The remote systems can include any processing system that is attempting to gain access to the main system or network, such as computer access, laptop access, telephone access, or any other desired system or device that is desired to have access through the main system.

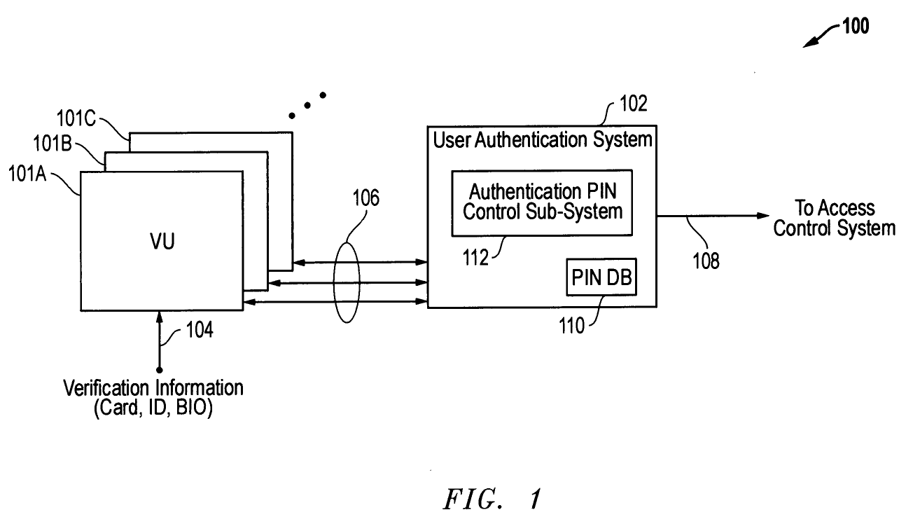

FIG. 1 shows an example embodiment of a user authentication environment 100 wherein data is received and transmitted for user authentication. Verification units 101A, 101B, 101C . . . perform user verification and send clearance/verification data to a user authentication system 102. A user enters verification information 104 into a verification unit 101A, 101B, 101C . . . , and this verification information 104 can include a wide variety of data types, including information such as information stored on a smart card, a user password or PIN, and biometric identification (e.g., fingerprint, eye scan). Once the user information is verified or authenticated through a verification unit 101A, 101B, 101C . . . and verification data is sent to the user authentication system 102, the user authentication system 102 generates an authentication-PIN associated with a positive verification of the user utilizing an authentication-PIN database 110 and an authentication-PIN control sub-system 112. The authentication-PIN database 110 is configured to store authentication-PINs corresponding to users. The authentication-PIN control sub-system 112 is configured to receive an authentication indication from a verification unit 101A, 101B, 101C . . . concerning the user of the smart card, configured to generate an authentication-PIN associated with a positive verification of the user, and configured to store the authentication-PIN information within the database. The smart card can be, for example, a Department of Defense Common Access Card. Once the authentication-PIN is generated by the authentication PIN control sub-system 112 of the user authentication system 102, the authentication-PIN is communicated to a user through the verification units 101A, 101B, 101C . . . , or through some other desired communication mechanism.

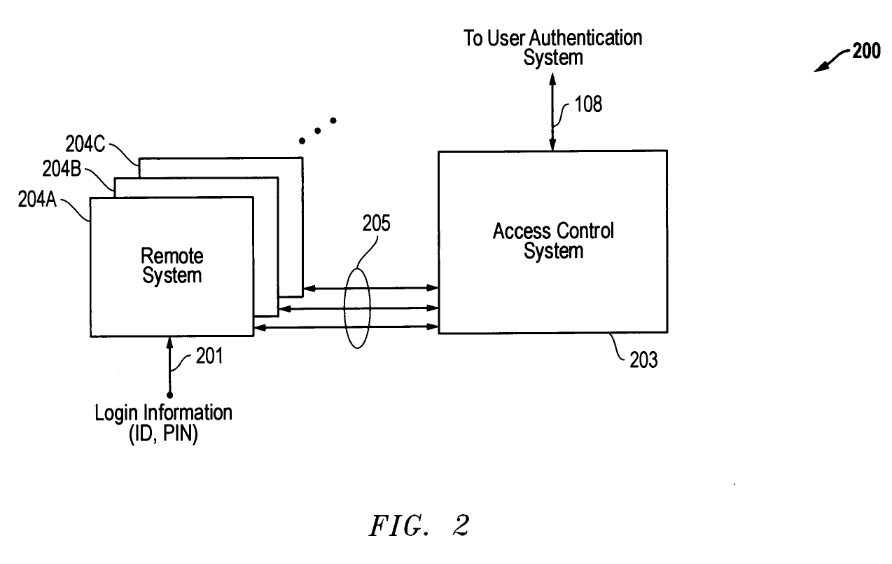

The authentication-PIN is required for a user to login to a remote system. When a user logs on to a remote system, as will be described in more detail with regard to FIGS. 2, 3, and 4, the user's authentication-PIN and/or other forms of identification, such as a password or a username, are received by the remote system and communicated to an access control system via communication link 108. As discussed in more detail below, the access control system controls access approval to the remote system and to related resources such as network servers. If the authentication-PIN is verified, the user authentication system 102 communicates this approval to the access control system.

If desired, the authentication-PIN can be temporary. For example, the authentication-PIN can be set to expire at a set time, after a set number of uses or upon some other set of parameters, as desired. For example, if a user is working on a project that ends at a certain date and/or time, the authentication-PIN can be set to expire at the same date/time as the project end date/time. As an additional example, if the user needs access to only one remote system or network resource and/or needs only a single access session, that user's authentication-PIN can be set to allow a single resource access and/or can be set to expire after one use, as desired, depending upon the access needed and/or requested by the user. Furthermore, if desired, the user authentication system 102 can include a user activity tracking component that tracks and stores user activities with respect to the system. Example tracking information that can be stored includes such information as all remote system login attempts, whether access was granted or denied, date and time of login attempts, and user identity.

FIG. 2 shows a remote system authentication environment 200. In one embodiment, a user enters into a remote system 204A, 204B, 204C . . . login information 201, such as identification information (such as a password or user-PIN, username and/or smart card data (such as DOD CAC card data) and the authentication-PIN. As discussed above, the authentication-PIN was previously issued or assigned by a user authentication system 102 after user verification by a verification unit 101, as shown in FIG. 1. The remote system 204A, 204B, 204C . . . communicates with an access control system 203 to provide the user identification information and the authentication-PIN from the remote system 204A, 204B, 204C . . . via communications links 205. The authentication-PIN is verified through communications between the access control system 203 and the user authentication system 102 via a communications link 108. It is noted that communication link 108, as with the other communication links discussed herein, can be any desired communication channel including wired or wireless communications either direct or through intervening systems. It is noted that the access control system 203 can be, for example, a network security access server that controls access to network client machines, network servers and network resources.

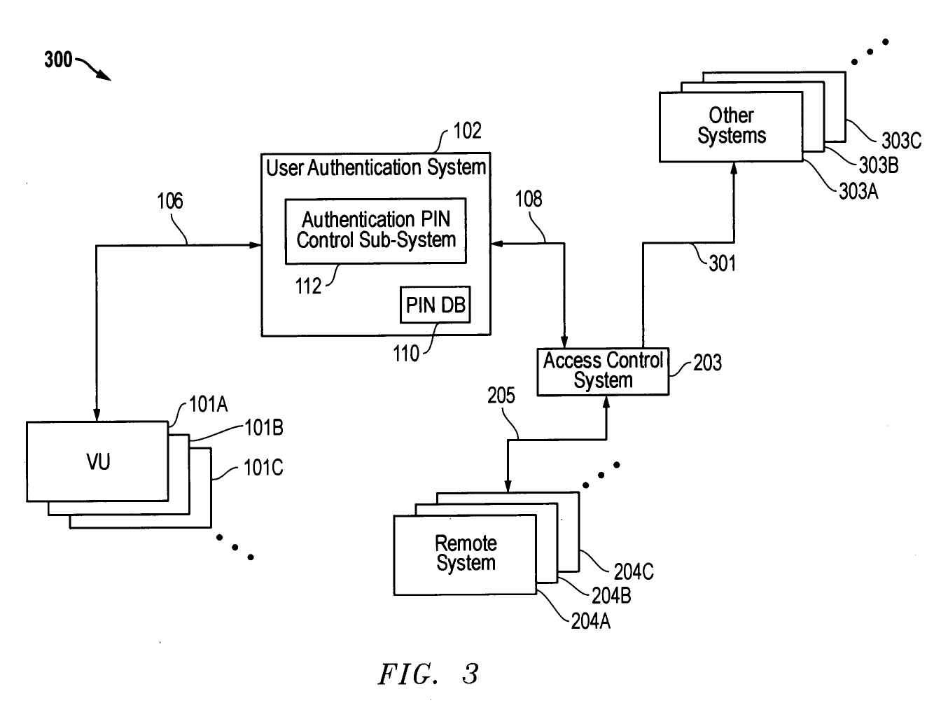

FIG. 3 shows an authentication system and remote system authentication environment 300. In one embodiment, verification units 101A, 101B, 101C . . . are configured to receive multiple types of verification information as inputs, including smart card information, biometric information (such as a fingerprint) and a password. The smart card can again be, for example, a DOD CAC card. Verification units 101A, 101B, 101C . . . are further configured to verify a user of the smart card based upon the verification information. The verification units 101A, 101B, 101C . . . connect through communication links 106 to a user authentication system 102 and provide to the user authentication system 102 verification indications concerning the user of the smart card. As discussed above, the user authentication system 102 is configured to generate an authentication-PIN from a PIN database 110 upon a positive verification of a user. The user authentication system 102 then provides the authentication-PIN to the verification units 101A, 101B, 101C . . . for receipt and use by the user of the smart card.

As shown in FIG. 3, the user authentication system 102 is connected to an access control system 203 via a communications link 108. The access control system 203 is connected to remote systems 204A, 204 B, 204C . . . via a communications links 205 and to other connected systems 303A, 303B,303C . . . via a communications link 301 to the other systems. It is noted that these other systems 303A, 303B, 303C may be, for example, network servers, network databases and/or other connected resources that are potentially accessible through the system as controlled by the access control system 203. The access control system 203 is configured to receive user login requests from remote systems 204A, 204B, 204C . . . including user identification information and authentication-PINs. The access control system 203 is further configured to communicate with the user authentication system 102 to verify the authentication-PIN and, if the authentication-PIN is verified, to approve access to a remote system 204A, 204B, 204C . . . and/or to other systems 303A, 303B, 303C . . . .

Certain security clearance level and/or project-related information can also be associated with a user through a smart card, through some other identification information, or can be held or stored within the user authentication system 102. The verification units 101A, 101B, 101C . . . can communicate to the access control system 203 security clearance level information of the user requesting authentication. The access control system 203 can be configured to use security levels and project information to control the user's access to remote system 204A, 204B, 204C . . . and applications, databases or other resources represented by the other systems 303A, 303B, 303C . . . such that a user can be given access, for example, to resources designated at a level equal to or below the user's security clearance level. Similarly, the verification units 101A, 101B, 101C . . . can communicate to the access control system 203 special access levels corresponding with the user requesting authentication. The access control system 203 can then assist the user in obtaining access to remote systems 204A, 204B, 204C . . . and to the other systems 303A, 303B, 303C . . . as allowed per the user's clearance for a special access level. Still further, the verification units 101A, 101B, 101C . . . can communicate to the access control system 203 special project lists corresponding to the user requesting authentication. The special project lists can help determine the remote systems 204A, 204B, 204C . . . and other systems 303A, 303B, 303C . . . to which a user needs access and will be granted access. Access attempts to remote systems 204A, 204B, 204C . . . and/or other systems 303A, 303B, 303C . . . by a user beyond those authorized would be denied.

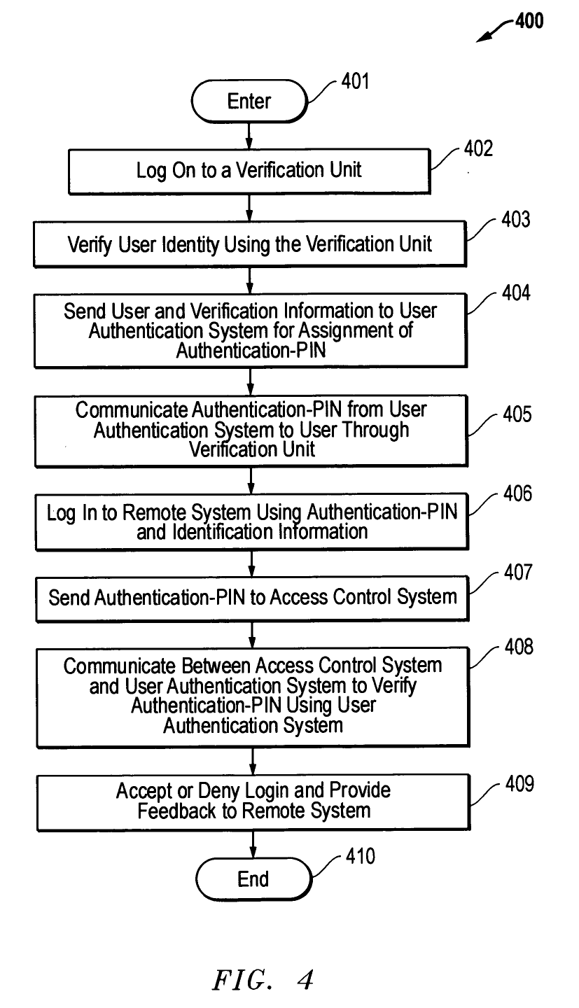

FIG. 4 shows the steps involved for an example embodiment 400 for securing user access to remote systems using a dual layer security system according to the present invention. From the start of the process in block 401, the user first logs on to a verification unit in step 402. The verification unit, for example, can receive information from a smart card corresponding to the user, such as information concerning the access card, information known by the user, and a biological indicator from the user. As indicated above, the smart card can be a DOD CAC card. In step 403, the verification unit verifies the user identification and provides a verification indication to the user once the information is verified. In step 404, the user information and verification information is communicated from the verification unit to a user authentication system. Temporary and/or permanent authentication-PINs are generated for verified users and stored in a user authentication system. In step 405, the temporary and/or permanent authentication-PIN is communicated to user from the user authentication system through the verification unit. Next, in block 406, a login request is received from the user logging on to a remote system, the login request includes user identification information and an authentication-PIN. The user identification information and the authentication-PIN are communicated from the remote system to an access control system in step 407. The authentication-PIN is verified using the user authentication system through communications between the access control system and the user authentication system in step 408. In step 409, the login is accepted or denied by the access control system and feedback is provided to remote system. The process then ends at block 410. It is again noted that the access control system can be, for example, a network security access server that controls access to network client machines, network servers and network resources.

### EXAMPLE

### Aircraft Communication System

In one application for the present invention, the access control system 203 can be a secure communication system on board an aircraft, and the remote systems 204A, 204B, 204C . . . can be computers, phones, navigation equipment and/or any other on board communications related equipment. A user can use the authentication-PIN to access remote systems 204A, 204B, 204C . . . throughout an aircraft without the need for a verification unit at each station or seat, resulting in an authentication system that saves space and weighs less than a stand alone verification system and separate authentication system at each station. The authentication-PIN allows access to stations or remote systems 204A, 204B, 204C . . . having a computer connections, laptop ports, telephone access, and the like. In one embodiment, the remote systems 204 A, 204B, 204C . . . have software configured to display a log-on box on a user's computer screen when a computer is plugged into an access port, such as an Ethernet connection, and when a computer attempts access to a wireless network. The software module provides an input screen for a user to enter user identification information (e.g., username, user-PIN, badge number, smart card number, user data stored on a smart card, etc.) and the authentication-PIN previously issued by a user authentication system 102. In addition, the authorization-PIN can be used for access to other systems. For example, when attempting to use a telephone (e.g., analog, digital, IP-base, etc.) and/or a cell phone on board the aircraft, a user can be prompted for user identification and the assigned authentication-PIN when the telephone is taken off hook or when the connection is attempted.

In this aircraft communications embodiment, the user authentication system 102 of the present invention can be considered a subsystem of the onboard access control and communication system 203. The communication system 203 can be configured to provide clear and secure voice, data and video communications for airborne platforms. The user authentication system 102 uses one or more verification units 101A, 101B, 101C . . . to verify the identity of users and acquire user permissions for the system. User permissions can include clearance levels, special access levels, special project lists, and/or other desired user permsission information. The verification unit 101 can utilize a variety of forms of verification and, preferably, includes three forms of verification—biometric, user-known password, and a physical item like a smart card. The authentication system 102 will receive from the verification units 101A, 101B, 101C . . . results of verification processing.

When a user enters their verification data into the verification unit, for example, using a smart ID card, the verification unit 101 verifies if the data is correct and matches the data stored on the ID card. If the verification with the ID card data fails, the verification unit 101 can send a rejection notice to the user authentication system 102 with the data that did not match. In one embodiment, the verification data can be a user name on the ID card, a user-PIN and biometric data. If the verification data does match, the verification unit 101 can send the user authentication system 102 approval related information, such as: user name, approval notice, user permissions, cell phone number, and any other desired information. Once it receives verification data and verification approval from the verification unit 101, the user authentication system 102 assigns to the user an authentication-PIN for subsequent use in logging into the main system 203. This authentication-PIN can be given back to the user through the verification unit 101 or through some other desired mechanism. The user then uses the authentication-PIN to access the main system throughout the aircraft. As such, the authorizatoin-PIN can be used to allow access to stations that have a computer, laptop ports, and telephone access.

As indicated above, there is no current system that communicates with and utilizes a verification unit as does the present invention. While products exist that will take three forms of authentication, although none are available for use with the DOD Common Access Card, these prior products are all stand alone units that at most send a time log back to a database to generate an access log. In contrast, the verificaiton unit 101 for the present invention passes to the user authentication system 102 more robust verfication data and user information such as the user's name and security clearance levels along with the verification approval information that is developed from the verification unit itself. In addition, if wireless phone access is to be controlled, the user's cell phone number can also be passed by the verication unit 101, if desired. The optional cell phone number is used to control later access to wireless communication subsystems within the main system 203. Also as indicated above, there are no systems currently available to store different security levels required to be able to cooperate with a multi-level security (MLS) system. Being compatible with an MLS system is important today because of the Global Information Grid (GIG) architecture that is being mandated by the Department of Defense with MLS as a piece of it. The system of the present invention receives and stores such information provided through the secure access card and the verification units.

In operation, the main system and its access points has software so that when a user plugs a laptop into an access port, a log-on box is displayed allowing the user to enter the user's name and the authentication-PIN that the user authentication system 102 assigned to the user for access to the main system 203. In addition, phones prompt for such a password when the phone is taken off hook.

A significant advantage to the operation of the present invention is that it can be implemented as an autonomous system thereby making the system extremely efficient. The system does not require a system operator or manager for routine use. User identity verification, user authorization, authorization-PIN generation and control, and user log-in to the main system can all be handled automatically by the dual level authorization system of the present invention. Not having to have all users entered into a central database ahead of time is a significant advantage when it comes to use in the U.S. Government. For example, for everyone who has a DOD Common Access Card, all the verification information needed is stored on the card. The verification unit can then authenticate and verify user identification according to the card. As such, the verification unit according to the present invention does not have to go search a remote database for verification information. It is noted that the verification unit can include a fingerprint reader, can allow entry of a user-PIN, and can allow swiping or input of a credit card style card. In addition, the verificaiton unit can include a screen that would work to relay information back to the user including the system defined authorization-PIN for the user.

In addition, the system of the present invention has an advantage for aircraft implementations because there is no requirement to have a verification unit at each seat thereby reducing weight requirements. Still further, tracking information could also be provided, such as keeping track of who makes calls, how many calls are made and the length of the calls in order to charge the appropriate agency or department for the air time. This tracking feature can be able to be turned on and off as needed.

It is noted that the present invention provides advantages to other implementations and applications, as well. For example, where personal access or identification (ID) card systems are utilized, the present invention allows for advantageous use of these cards. Instead of having to have every card verification unit connected to a main database with all the information stored about every user, the present invention provides the user authentication system 102 that streamlines the process. The verification unit verifies a match to the ID card and sends a simplified set of data to the user authentication system. Security is improved because sensitive access card data, such as biometric data, does not need to be communicated through wired or wireless communication networks to a central database for verificaiton processing. The verification approval information, along with other desired information, is what is transmitted to the user authentication system. The user authentication system then generates authentication PINs, which are preferably separate and distinct from the user-PINs, and these authentication PINs can be used for access to the systems. In addition, these authentication PINs can be temporal so that access is only allowed under particular parameters. Large entities, such as universities, corporations, organizations, etc. could take advantge of the present invention by implementing smart card systems and allowing the system of the present invention to control access to systems, such as computer labs.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A dual layer authentication system for securing user access to remote systems, comprising:
a verification unit configured to receive multiple types of verification information as inputs including information stored on a smart card and further configured to verify a user of the smart card based upon the verification information;
a user authentication system coupled to the verification unit to receive a verification indication concerning the user of the smart card, the user authentication system being configured to generate an authentication personal identification number (authentication-PIN) associated with a positive verification of the user and to provide the authentication-PIN to the verification unit for receipt by the user of the smart card; and
an access control system coupled to the user authentication system, the access control system being configured to receive user login requests from remote systems including user identification and the authentication-PIN, to communicate with the user authentication system to verify the authentication-PIN, and to approve access to a remote system if the authentication-PIN is verified.

2. The system of claim 1, wherein the verification unit requires at least three types of verification information to verify a user of the smart card, including identification information known by the user, identification information possessed by the user, and a biological indicator from the user.

3. The system of claim 1, further comprising an authentication-PIN database within the user authentication system, the authentication-PIN database configured to store authentication-PINs corresponding to users.

4. The system of claim 3, further comprising an authentication-PIN control sub-system within the user authentication system, the control sub-system configured to receive the verification indication from a verification unit concerning the user of the smart card, to generate the authorization-PIN associated with a positive verification of the user, and to store authentication-PIN information within the database.

5. The system of claim 4, wherein the authentication-PIN is temporary.

6. The system of claim 4, wherein the authentication-PIN expires after a set amount of time or a set number of logins.

7. The system of claim 4, wherein the smart card is a Department of Defense Common Access Card.

8. The system of claim 7, wherein the verification unit communicates to the access control system security clearance level information of the user requesting authentication.

9. The system of claim 7, wherein the verification unit communicates to the access control system special access levels corresponding with the user requesting authentication.

10. The system of claim 7, wherein the verification unit communicates to the access control system special project lists corresponding to the user requesting authentication.

11. The system of claim 4, further comprising a user activity tracking component.

12. A user authentication system configured to receive and transmit data for user authentication to a remote system, comprising:
a database configured to store authentication-PINs corresponding to users; and
a control sub-system configured to receive a verification indication from a verification unit concerning the user of a smart card, to generate an authentication personal identification number (authentication-PIN) associated with a positive authentication of the user, and to store the authentication-PIN information within the database.

13. The system of claim 12, wherein the verification unit is coupled to the user authentication system through wireless communication connections, through wired communication connections, or through both.

14. The system of claim 13, wherein the verification unit is configured to receive multiple types of verification information as inputs including smart card information and is further configured to verify a user of the smart card based upon the verification information.

15. The system of claim 14, wherein the user authentication system is coupled to an access control system for a plurality of remote systems.

16. The system of claim 15, wherein the access control system is configured to receive user login requests from remote systems including user identification and an authentication-PIN, to communicate with the user authentication system to verify the authentication-PIN, and to approve access to a remote system if the authentication-PIN is verified.

17. A method of securing user access to remote systems using a dual layer authentication system, comprising:
using a verification unit to receive verification information from a user and to verify an identity of the user;
communicating user information and verification information from the verification unit to a user authentication system;
generating temporary authentication-PINs for verified users and storing the authentication-PINs in a user authentication system;
communicating to a user the temporary authentication-PIN from the user authentication system through the verification unit;
receiving a login request from a user on to a remote system, the login request including user identification information and an authentication-PIN;
communicating the user identification information and the authentication-PIN from the remote system to an access control system; and
verifying the authentication-PIN through communications between the access control system and the user authentication system.

18. The method of claim 17, further comprising storing authentication-PINs and corresponding user information in a database.

19. The method of claim 17, wherein the using a verification unit step comprises receiving multiple types of verification information.

20. The method of claim 19, wherein the using a verification unit step comprises receiving information from a smart card corresponding to a user, identification information known by the user and a biological indicator from the user.

21. The method of claim 20, wherein the authentication-PIN is temporary with a set expiration time.

22. The method of claim 20, wherein the authentication-PIN expires after a set number of logins.

23. The method of claim 20, wherein the smart card is a Department of Defense Common Access Card.

24. The method of claim 23, further comprising obtaining security clearance information from the smart card and communicating security clearance level information from the verification unit to the user authentication system and from the user authentication system to the access control system.
